(19) United States
(12) Patent Application Publication
(10) Pub. No.: US 2025/0016595 A1
(43) Pub. Date: Jan. 9, 2025

(54) SYSTEM AND METHOD FOR JOINT SENSING OF INTERFERENCE IN A WIRELESS NETWORK

(71) Applicant: Huawei Technologies Co., Ltd., Shenzhen (CN)

(72) Inventors: Yongxia Lyu, Kanata (CA); Jianglei Ma, Ottawa (CA); Peiying Zhu, Kanata (CA); Yiqun Ge, Kanata (CA)

(21) Appl. No.: 18/883,475

(22) Filed: Sep. 12, 2024

Related U.S. Application Data
(63) Continuation of application No. PCT/CN2022/081011, filed on Mar. 15, 2022.

(51) Int. Cl. H04W 24/10; H04B 7/06; H04B 17/309

(52) U.S. Cl. CPC H04W 24/10; H04B 7/0617; H04B 17/346

(57) ABSTRACT

Systems and methods of reporting wireless channel state information are provided. With the provided system and method, in a situation where there are multiple UEs which are close to each other, such that channel conditions may be similar for the multiple UEs, one of the UEs is configured to report interference information on a time pattern that has at least two measurement time durations for which interference is to be measured, for example, only for a subset of N consecutive measurement time durations. Other UEs may be configured to report interference information for different time patterns, for example different subsets of the N time slots.

### CROSS-REFERENCE TO RELATED APPLICATION

This application is a continuation of International Application No. PCT/CN2022/081011, filed on Mar. 15, 2022, the aforementioned patent applications is hereby incorporated by reference in its entirety.

### TECHNICAL FIELD

The application relates to wireless communications generally, and more specifically to systems and methods of sensing interference in a wireless network.

### BACKGROUND

Sensor networks can be used to monitor the state or behavior of a particular environment. For example, in a factory, a wireless sensor network (WSN) can be used to monitor a process and the corresponding parameters in an industrial environment. This environment is typically monitored using various types of sensors such as microphones, CO₂ sensors, pressure sensors, humidity sensors, and thermometers. These sensors usually form a distributed monitoring system. The monitored data from such a system, is used to detect anomalies in the data, i.e., by leveraging machine learning (ML) algorithms. These algorithms usually require a training phase before a trained ML algorithm can later work on a subset of the available measured data. However, the training as well as the analysis of the data may be realized in a centralized or distributed manner.

A wireless sensor node is a device that possesses a sensing capability and wireless communication capabilities. Advanced wireless sensor nodes also have a computation capability as well but simple wireless sensor nodes do not typically have such a capability. A WSN may comprise both simple wireless sensor nodes and advanced wireless sensor nodes. Depending on their sensing components and the application requirements, sensor nodes can be used to monitor different phenomena like temperature, light, motion, pressure, humidity and audio etc. The wireless communication module in a wireless sensor node is used to send and receive the data packets over the WSN. When the wireless sensor node also has a computation capability, the processing module of this wireless sensor node is able to do computation on the sensed data and also on the data received from other sensors. Since a single wireless sensor node provides only limited information, a network of these wireless sensor nodes is used to provide coverage over a large area. Typically, wireless sensor nodes are battery powered and have a limited battery power, and therefore energy consumption is an important issue for WSNs and imposes a constraint on WSNs. This constraint requires these wireless sensor nodes to operate in an energy efficient manner in order to prolong the network lifetime while at the same time achieving performance requirements.

### SUMMARY

New systems and methods of reporting wireless channel state information are desired to make these sensor nodes operate in an energy efficient manner in order to prolong the network lifetime while achieving reliability and latency requirements.

With the provided system and method, in a situation where there are multiple UEs which are close to each other, such that channel conditions may be similar for the multiple UEs, one of the UEs is configured to report interference information on a time pattern that has at least two measurement time durations for which interference is to be measured, for example, only for a subset of N consecutive measurement time durations. Other UEs may be configured to report interference information for different time patterns, for example different subsets of the N time slots.

According to one aspect of the present disclosure, there is provided a method for reporting interference information in an apparatus, comprising: receiving an indication to report interference information on a first time pattern, the first time pattern having at least two measurement time durations for which interference is to be measured; transmitting interference information associated with the at least two measurement time durations, wherein the interference information associated with the at least two measurement time durations comprises: a respective interference level for each of the at least two measurement time durations; or an interference derivate based on measurements for the at least two measurement time durations; or acceleration of interference derivate based on measurements for the at least two measurement time durations.

In some embodiments, the method further comprises receiving an indication of the first time pattern.

In some embodiments, receiving the indication to report interference comprises receiving a first message comprising the indication to report interference and receiving the indication of the first pattern comprises receiving a second message comprising the indication of the first pattern.

In some embodiments, the transmitted interference information is for a specific azimuth angle.

In some embodiments, the method further comprises one of: receiving an indication of the specific azimuth angle; or determining the specific azimuth angle as the azimuth angle with the worst interference for a given measurement time duration; or determining the specific azimuth angle as the azimuth angle with the lowest interference for a given measurement time duration.

In some embodiments, the transmitted interference information further including an indication of the specific azimuth angle.

In some embodiments, the method further comprises: receiving signaling that configures which interference information is to be reported.

In some embodiments, the apparatus is a wireless sensor node.

In some embodiments, transmitting the interference information comprises one of: transmitting a single bit indicating one of two interference levels or interference derivates or acceleration of interference derivates; transmitting two bits indicating one of up to four interference levels or interference derivates or acceleration of interference derivates; or transmitting three bits indicating one of up to eight interference levels or interference derivates or acceleration of interference derivates.

According to another aspect of the present disclosure, there is provided an apparatus comprising a processor and a memory, the network element configured to perform a method for obtaining interference information as described herein.

According to another aspect of the present disclosure, there is provided a method for obtaining interference information in a wireless network, the method comprising: transmitting an indication to an apparatus to report interference information on a first time pattern, the first time pattern having at least two measurement time durations for which interference is to be measured by the apparatus; receiving interference information associated with the at least two measurement time durations, wherein the interference information associated with the at least two measurement time durations comprises: a respective interference level for each of the at least two measurement time durations; or an interference derivate based on measurements for the at least two measurement time durations; or acceleration of interference derivate based on measurements for the at least two measurement time durations.

In some embodiments, the method further comprises transmitting an indication of the first time pattern.

In some embodiments, transmitting the indication to report interference comprises transmitting a first message comprising the indication to report interference and transmitting the indication of the first pattern comprises transmitting a second message comprising the indication of the first pattern.

In some embodiments, the received interference information is for a specific azimuth angle.

In some embodiments, the method further comprises one of: transmitting an indication of the specific azimuth angle; or the received interference information includes an indication of the specific azimuth angle.

In some embodiments, the method further comprises: transmitting signaling that configures which interference information is to be reported.

In some embodiments, the method further comprises: making a scheduling or routing decision based on the received interference information.

In some embodiments, the wireless network is a wireless sensor network.

In some embodiments, receiving the interference information comprises one of: receiving a single bit indicating one of two interference levels or interference derivates or acceleration of interference derivates; receiving two bits indicating one of up to four interference levels or interference derivates or acceleration of interference derivates; or receiving three bits indicating one of up to eight interference levels or interference derivates or acceleration of interference derivates.

According to another aspect of the present disclosure, there is provided a network element comprising a processor and a memory, the network element configured to perform a method for obtaining interference information as described herein.

According to another aspect of the present disclosure, there is provided a non-transitory computer-readable medium having stored thereon, computer-executable instructions, that when executed by a computer, cause the computer to perform one of the methods as described herein.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5 is a flowchart of base station/apparatus functionality for reduced overhead interference reporting;

FIG. 6 is a flowchart of UE/device functionality for reduced overhead interference reporting;

FIG. 7 is a signal flow diagram showing messaging between the UE and the network;

FIG. 8 is a block diagram of a communication system showing a specific example of a star topology for a WSN; and

FIG. 9 is a block diagram showing messaging between the UE and the network.

### DETAILED DESCRIPTION OF THE EMBODIMENTS

A WSN may have a communication service reliability requirement for a specified end-to end latency requirement. One example of a communication service reliability requirement is an availability that is larger than 99.9999% or 99.999999% and an example of an end-to-end latency requirement is 5 ms-10 ms. In current wireless communication system, for example LTE and 5G, a base station (BS) obtains wireless downlink channel state information from channel quality information (CQI) reported by each user equipment (UE) (a wireless sensor node is a specific example of a UE); wireless uplink channel state information is obtained by processing sounding reference signal (SRS) transmissions sent by each UE. Knowledge of both wireless downlink and uplink channel state in advance of scheduling is very important for a base station or gateway to accommodate the requirements of communication service availability and end-to end latency requirement. However, sensing the wireless channel state regularly, and transmitting CQI or SRS based feedback is a significant drain on the limited battery power of wireless sensor nodes.

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

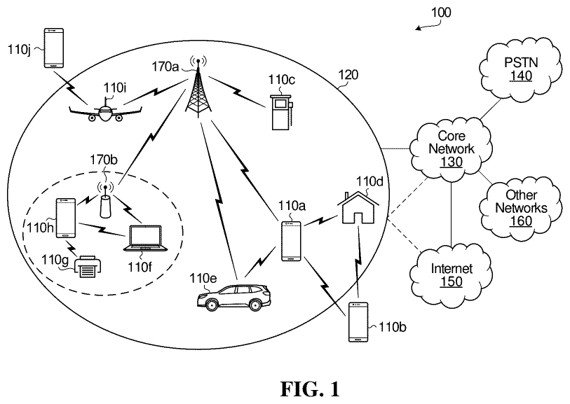

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

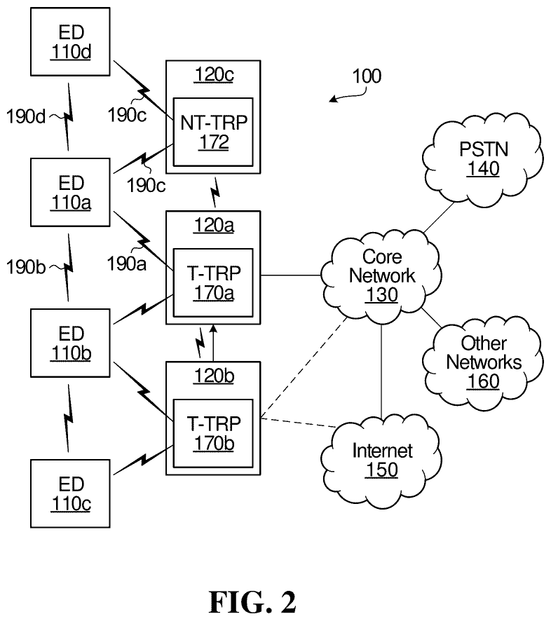

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

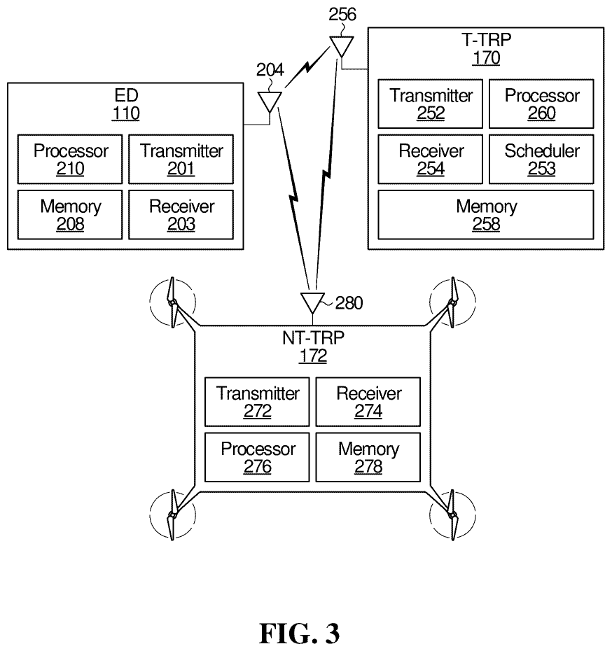

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

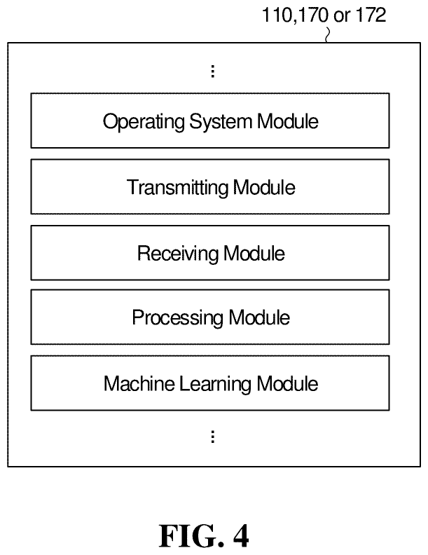

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

New systems and methods of reporting wireless channel state information are desired to make these sensor nodes operate in an energy efficient manner in order to prolong the network lifetime while achieving reliability and latency requirements.

With the provided system and method, in a situation where there are multiple UEs which are close to each other, such that channel conditions may be similar for the multiple UEs, one of the UEs is configured to report interference information on a time pattern that has at least two measurement durations (or time slots) for which interference is to be measured, for example, only for a subset of N consecutive time slots. For example, a measurement time duration can be one symbol, seven symbols, 14 symbols, or some other number of symbols. Consider a specific example, where patterns are defined over 10 consecutive time slots numbered 1 to 10 for reference purposes. A first UE may be configured to report interference on a time pattern that includes time slots 1,3,5,7,9.

Other UEs may be configured to report interference information for different time patterns, for example different subsets of the N time slots. Continuing with the example above, another UE may be configured to report on a time pattern that includes time slots 2,4,6,8,10. If each of the N time slots is included in at least one of the subsets, then based on the interference information reported by the UEs collectively, the base station will receive interference information for all N time slots, and will be able to obtain a complete picture of interference information on the N continuous time slots. The pattern of reporting may then repeat for the next set of N consecutive time slots. In some embodiments, the UE reports for some fixed number of sets of N consecutive time slots; in some embodiments, the UE continues reporting based on the pattern until instructed to stop, or until instructed to use a different pattern.

In the described embodiments, rather than transmitting full CQI information, interference information is transmitted. CQI indicates the quality of wireless channel, CQI is usually represented by signal to interference plus noise ratio (SINR); interference information is represented by only an interference value received or measured by UE. In a situation where the UE are positioned close to the BS, such as would be the case for a WSN in a factory for example, the UE is not transmit power-limited; the key factor to impact the block error rate or the high reliability of transmitting and receiving sensed data over a wireless channel within certain low latency boundary is not the UE's transmit power, but interference. The UE are configured to only measure/sense interference from other nodes; by not sensing other parameters typically reported as part of CQI as part of full wireless channel measurement for example as specified in LTE and NR, this reduces the complexity of the UE, and is helpful for power consumption reduction.

The nature of the interference information can be configured by a BS or predefined, for example, in a standard specification. Examples of the interference information that may be reported include:
i. a respective interference level for each of the at least two measurement time durations; in a case where the time pattern includes a subset of N consecutive time slots, the interference information would include interference levels on each of the subset of N consecutive time slots. In this case, if the subset includes M time slots, the interference information includes M interference levels, one for each of the M time slots. The interference level can be received energy from one or more unexpected signals (also called as interference signal). Expected signal carry the valid information for a UE, and the UE is able to receive the expected signal correctly with certain assumptions or rules, and then demodulate and decode the expected signal to get the carried information. The unexpected signal for the UE can be expected signal for the other UE.
ii. an interference derivate based on measurements for the at least two measurement time durations; in a case where the time pattern includes a subset of N consecutive time slots, this could be an interference derivate based on interference levels for the subset of N continuous time slots. In this case, the interference levels for the M time slots are obtained by the device, and interference information for the M time slots collectively is determined based on a derivation from the M interference levels. For example, the interference derivate may be the average of the M individual interference levels.
iii. acceleration of interference derivate based on measurements for the at least two measurement time durations; in a case where the time pattern includes a subset of N consecutive time slots, this could be an interference derivate on the subset of N continuous time slots, where the manner of determining the derivate changes over time. For example, initially, the interference information that is transmitted may include a respective interference level for each of the M time slots; after some time, the interference information that is transmitted is an average interference level for pairs of two time slots among the set of M time slots; finally, after some further time, the interference information that is transmitted is a single interference derivate based on all of the interference levels for the M time slots.

In a specific example of iii, the UE is configured to report interference levels for all time slots of the time pattern in a training phase of an ML algorithm. Then, an interference derivate, or interference derivate that changes over can be configured to be reported after the training phase of ML algorithms to further reduce reporting overhead and save UE power consumption.

In some embodiments, specific formats for reporting the interference information are used that are efficient in terms of number of bits. Specific example formats are provided below based on 1 bit, 2 bits, and 3 bits. In such cases, there are limited options for reporting interference information. For example, in the 1 bit case, only two options can be reported. When this is the case, a simplified interference measurement/sensing can also be performed which may further reduce power consumption associated with reporting interference measurements, since the UE only needs to perform enough measurement to distinguish between the two options that can be reported.

In some embodiments, some UE have a capability to sense/measure interference per certain azimuth angle, in which case interference information is specific to an azimuth angle. In some embodiments, the BS indicates the azimuth angle that a given UE is to measure. In some embodiments, the UE measures interference for multiple azimuth angles in a time slot, and determines which azimuth angle has the strongest interference. The interference level for the azimuth angle with the strongest interference in a time slot is reported. In some embodiments the azimuth angle per se with the strongest interference is also reported. Alternatively or in addition, the interference level for the azimuth angle with the weakest interference in a time slot is reported. In some embodiments, the azimuth angle per se with the weakest interference is also reported.

The provided approach can be used for a WSN, but more generally can be applied to any wireless network in which there is a goal of achieving/reporting wireless channel state information in an energy efficient manner while achieving the certain reliability and latency requirements. Other examples include V2X, unlicensed-LTE or NR, cellular LTE or NR.

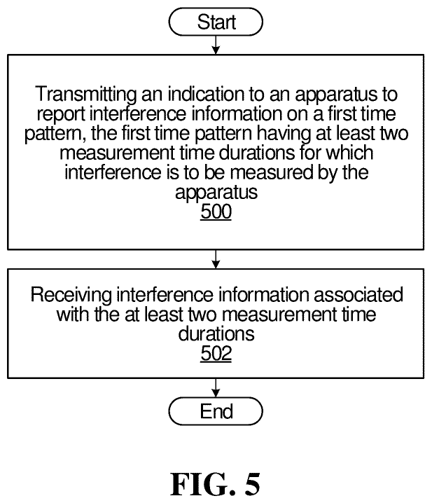

Referring now to FIG. 5, shown is a flowchart of BS functionality for the reduced overhead interference reporting. At 500, the BS transmits an indication to a UE to report interference information over a first time pattern. The first time pattern has at least two measurement time durations for which interference is to be measured by the UE. More generally, a step similar to step 500 can be performed for multiple UE, for example, a set of wireless sensor nodes in a WSN. The BS may determine the patterns, and the UE to transmit using each pattern, to ensure that for a given time slot, there are enough UE reporting interference information. At 504, the BS receives interference information associated with the at least one measurement time duration for which interference is to be reported by the UE. As discussed above, this can be an interference level for each measurement time duration, or it can be a value derived from these interference levels. A step similar to 504 may be performed for multiple UE. At this point, in a situation where each time slot is included in at least one pattern, the BS will have a complete picture of interference for all of the time slots.

As described above, a base station transmits the indication to report interference information, and receives interference information in return. More generally, this functionality can be implemented in any apparatus that has the capability for radio transmission and reception for the multiple UE. Other examples include gateway nodes that have transmission and reception capability, or full BS functions. A base station is a network element in radio access network responsible for radio transmission and reception in one or more cells to or from the user equipment. The apparatus can have an integrated antenna or be connected to an antenna by feeder cables.

The indication transmitted in 500 may be a message transmitted as physical layer control signaling, for example, downlink control information (DCI) transmitted on a physical downlink control channel (PDCCH). Alternatively, the indication can be part of a message transmitted as higher layer control signaling, such as RRC signaling. In some embodiments, each UE has previously obtained the time pattern, and the indication simply informs the UE to report interference information using the time previously obtained time pattern.

Information about the time pattern per se may be indicated in the same message that indicates to the UE to report interference, or the time pattern per se may be indicated in a separate message, for example higher layer signaling message.

In some embodiments, a bitmap is used to indicate which time slots to measure and report. For example, if there is to be a repeating pattern of 10 time slots, 10 bits can be used to indicate which of the 10 time slots a UE is to measure and report. In another example, there is a set of predefined patterns, each having an associated index. The index is used to indicate to the UE which pattern to use, and thereby to indicate which time slots to measure and report.

The nature of the interference information to be reported can be configured by the BS or predefined, for example in a standard specification. Any of the examples described above can be employed, but the interference information is not limited to these specific examples. Examples given above have included interference levels for each time slot in the time pattern, interference derivate based on interference levels for the time slots on the time pattern, and interference derivate that changes over time.

The configuration of which kind of interference information is to be reported can be indicated by physical layer signaling or higher layer signaling. The information of which kind of interference information reported can be included:
in a dedicated message; or
in a message that is also used to indicate the time pattern per se; or
in a message that is also used to indicate to the UE to report interference information; or
in a message that is also used to indicate to the UE to report interference information and to indicate the time pattern per se.

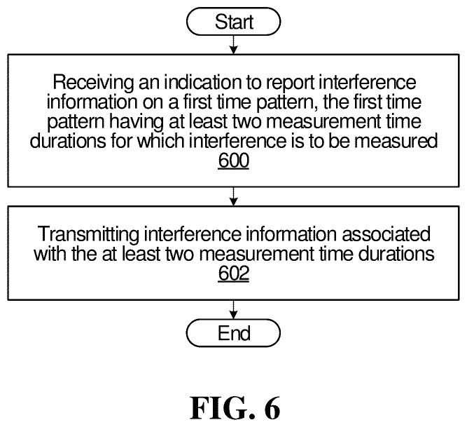

Referring now to FIG. 6, shown is a flowchart of UE functionality for the reduced overhead interference reporting. At 600, the UE receives an indication to report interference on a first time pattern, the first time pattern having at least two measurement time durations for which interference information is to be measured. At 602, the UE transmits interference information associated with the at least one measurement time. This embodiment can be implemented using any of the approaches described previously for the signaling to indicate to the UE to report interference information, to indicate the time pattern, and to indicate the nature of the interference information reported.

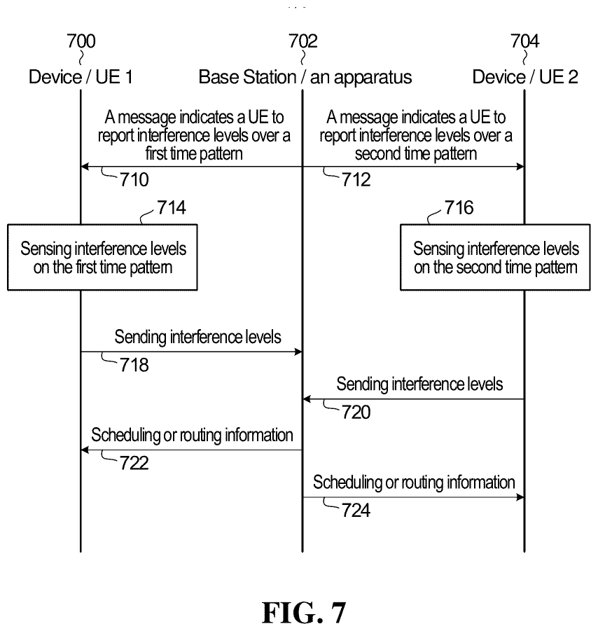

FIG. 7 is a signal flow diagram showing a specific example of messaging between the UE and the network. Shown is a first device/UE 1 700, a second device/UE 2 704, and a base station/apparatus 702. At 710, the base station/apparatus 702 transmits a message indicating to the first device UE 1 700 to report interference levels (more generally interference information) on a first time pattern. At 712, the base station/apparatus 702 transmits a message indicating to the second device UE 2 702 to report interference levels (more generally interference information) on a second time pattern. At 714, the first device/UE 1 700 senses interference levels on the first time pattern. At 716, the second device/UE 2 700 senses interference levels on the second time pattern. At 718, the first device/UE 1 700 sends interference levels to the base station/apparatus. At 720, the second device/UE 2 702 sends interference levels to the base station/apparatus. At 724, the base station/apparatus 702 sends scheduling or routing information to the first device/UE 1 700. At 726, the base station/apparatus 702 sends scheduling or routing information to the second device/UE 2 702. Scheduling and routing is discussed further below. While the examples refers to transmitting interference information in the form of interference levels, alternatively, the other approaches described above based on interference derivate or acceleration of interference derivate can be used.

### DETAILED EXAMPLES OF INTERFERENCE INFORMATION

TABLE 1
interference level information with 1 bit

| Interference | Indicated | |
|---|---|---|
| level | inter- | |
| information | ference | |
| (1 bit) | level | Physical meaning and condition |
| 0 | 0 or False | No interference is assumed when |
| | | sensed/measured energy during a |
| | | time slot is less than or no more than |
| | | a threshold A, or no valid interference is |
| | | measured/sensed, or the measured/sensed |
| | | interference is out of receiver sensitivity. |
| | | The indicated interference level can be |
| | | Boolean constant FALSE, or o |
| 1 | 1 or True | Interference is reported when sensed |
| | | energy during a time slot is no less |
| | | than/more than a threshold A, for example |
| | | can be Boolean constant True or 1 |

TABLE 2
interference level information with 2 bits

| Interference | Indicated | |
|---|---|---|
| level | inter- | |
| information | ference | |
| (2 bit) | level | Physical meaning and condition |
| 00 | 0 | No interference is assumed when |
| | | sensed/measured energy during a time |
| | | slot is less than or no more than a |
| | | threshold B, or no valid interference is |
| | | measured/sensed, or the measured/sensed |
| | | interference is out of receiver sensitivity. |
| 01 | 1 | The first interference level is assumed/ |
| | | reported when sensed/measured energy |
| | | during a time slot is no less than or more |
| | | than a threshold B, and less than or no |
| | | more than a threshold C. For example, |
| | | [threshold B, threshold C) |
| 10 | 2 | The second interference level is |
| | | assumed/reported when sensed/measured |
| | | energy during a time slot is no less than |
| | | or more than a threshold C, and less |
| | | than or no more than a threshold D. For |
| | | example, [threshold C, threshold D) |
| 11 | 3 | The third interference level is assumed/ |
| | | reported when sensed/measured energy |
| | | during a time slot is no less than a |
| | | threshold E. For example, [threshold |
| | | E, Max detected energy by the receiver |
| | | or infinity). |

TABLE 3
interference level information with 3 bit

| Interference | Indicated | |
|---|---|---|
| level | inter- | |
| information | ference | |
| (3 bit) | level | Physical meaning and condition |
| 000 | 0 | No interference is assumed when |
| | | sensed/measured energy during a time |
| | | slot is less than or no more than a |
| | | threshold B, or no valid interference is |
| | | measured/sensed, or the measured/sensed |
| | | interference is out of receiver sensitivity. |
| 001 | 1 | The first interference level is assumed/ |
| | | reported when sensed/measured energy |
| | | during a time slot is no less than or more |
| | | than a threshold F, and less than or no |
| | | more than a threshold G. For example, |
| | | [threshold F, threshold G) |
| 010 | 2 | The second interference level is assumed/ |
| | | reported when sensed/measured energy |
| | | during a time slot is no less than or more |
| | | than a threshold G, and less than or no |
| | | more than a threshold H. For example,, |
| | | [threshold G, threshold H) |
| 011 | 3 | The third interference level is assumed/ |
| | | reported when sensed/measured energy |
| | | during a time slot is no less than or more |
| | | than a threshold H, and less than or no |
| | | more than a threshold I. For example,, |
| | | [threshold H, threshold I) |
| 100 | 4 | The fourth interference level is assumed/ |
| | | reported when sensed/measured energy |
| | | during a time slot is no less than or more |
| | | than a threshold I, and less than or no |
| | | more than a threshold J. For example, |
| | | [threshold I, threshold J) |
| 101 | 5 | The fifth interference level is assumed/ |
| | | reported when sensed/measured energy |
| | | during a time slot is no less than or more |
| | | than a threshold J, and less than or no |
| | | more than a threshold K. For example, |
| | | [threshold J, threshold K) |
| 110 | 6 | The sixth interference level is assumed/ |
| | | reported when sensed/measured energy |
| | | during a time slot is no less than or |
| | | more than a threshold K, and less |
| | | than or no more than a threshold L. For |
| | | example, [threshold K, threshold L) |
| 111 | 7 | The seventh interference level is assumed/ |
| | | reported when sensed/measured energy |
| | | during a time slot is no less than or |
| | | more than a threshold L, for example, |
| | | [threshold L, Max detectable energy by |
| | | the receiver or infinity). |

### If Interference Information is Interference Derivate/on the Time Pattern

TABLE 4
interference derivate/information with 1 bit

| Inter- | Indicated | |
|---|---|---|
| ference | inter- | |
| derivate | ference | |
| (1 bit) | level | Physical meaning and condition |
| 0 | 0 | When sensed/measured energy derivate |
| | | during the time pattern is less than or no |
| | | more than a threshold I, or no valid |
| | | interference is measured/sensed, or the |
| | | measured/sensed interference is out of |
| | | receiver sensitivity. |
| 1 | 1 | When sensed/measured energy derivate |
| | | during the time pattern is no less than or |
| | | more than a threshold I. |

TABLE 5
interference derivate/information with 2 bits

| Interference | Indicated | |
|---|---|---|
| level | inter- | |
| information | ference | |
| (2 bit) | level | Physical meaning and condition |
| 00 | 0 | When sensed/measured energy derivate |
| | | during the time pattern is less than or |
| | | no more than a threshold J, or no |
| | | valid interference is measured/sensed, |
| | | or the measured/sensed interference |
| | | is out of receiver sensitivity. |
| 01 | 1 | When sensed/measured energy derivate |
| | | during the time pattern is no less than |
| | | or more than a threshold J and less than |
| | | or no more than a threshold K. |
| 10 | 2 | When sensed/measured energy derivate |
| | | during the time pattern is no less than |
| | | or more than a threshold K and less |
| | | than or no more than a threshold L. |
| 11 | 3 | When sensed/measured energy derivate |
| | | during the time pattern is no less |
| | | than or more than a threshold L, |
| | | [threshold L, Max detected energy |
| | | by the receiver or infinity). |

TABLE 6
interference derivate/information with 3 bits

| Interference | Indicated | |
|---|---|---|
| level | inter- | |
| information | ference | |
| (3 bit) | level | Physical meaning and condition |
| 000 | 0 | When sensed/measured energy derivate |
| | | during the time pattern is less than |
| | | or no more than a threshold M, or no |
| | | valid interference is measured/sensed, |
| | | or the measured/sensed interference |
| | | is out of receiver sensitivity. |
| 001 | 1 | When sensed/measured energy derivate |
| | | during the time pattern is no less than |
| | | or more than a threshold M and less than |
| | | or no more than a threshold N. |
| 010 | 2 | When sensed/measured energy derivate |
| | | during the time pattern is no less than |
| | | or more than a threshold N and less |
| | | than or no more than a threshold O. |
| 011 | 3 | When sensed/measured energy derivate |
| | | during the time pattern is no less than |
| | | or more than a threshold O and less |
| | | than or no more than a threshold P. |
| 100 | 4 | When sensed/measured energy derivate |
| | | during the time pattern is no less than or |
| | | more than a threshold P and less than |
| | | or no more than a threshold Q. |
| 101 | 5 | When sensed/measured energy derivate |
| | | during the time pattern is no less than |
| | | or more than a threshold Q and less |
| | | than or no more than a threshold R. |
| 110 | 6 | When sensed/measured energy derivate |
| | | during the time pattern is no less than or |
| | | more than a threshold R and less than |
| | | or no more than a threshold S. |
| 111 | 7 | When sensed/measured energy derivate |
| | | during the time pattern is no less than or |
| | | more than a threshold S, [threshold S, |
| | | Max detected energy by the receiver |
| | | or infinity). |

Tables similar to tables 4 to 6 can be used to convey interference information that is based on interference derivate with a definition that changes over time. The thresholds can be the same or different.

The thresholds in the above tables can be predefined, for example in a standard specification, or can be configured by a BS by broadcast signaling or by transmitting UE specific signaling, such as RRC signaling.

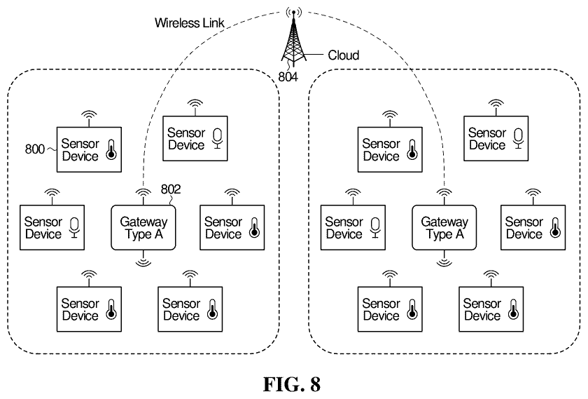

In some embodiments, the UE are connected to the network in a star topology. FIG. 8 shows a specific example of a star topology for a WSN. A number of sensor nodes (e.g. 800) are connected to a local gateway (e.g. 802 which may function as a small cell in wireless cellular network) which connects to a macro base station (e.g. 804) at the edge to the cloud network. Hence, the local gateway aggregates and forwards monitoring data. Also, while aggregating, the local gateway may pre-process the incoming data to reduce traffic load to the cloud and computational resource requirements on the cloud. A local gateway needs to dynamically handle the attachment requests and detachment events of sensor nodes without disruption of the monitoring service. One or more of the UE in FIG. 8 are configured to perform one of the interference reporting methods described above.

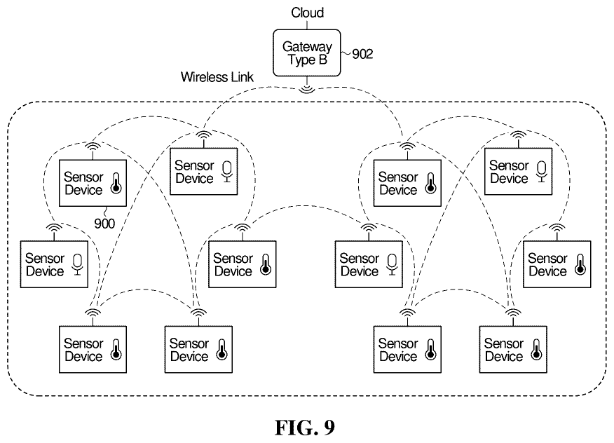

In some embodiments, the UE are connected in a mesh topology. A specific example is shown in FIG. 9. Here, a set of sensor nodes (e.g. 900) is directly interconnected as a mesh, where one sensor nodes provides an uplink to a serving gateway (e.g. 902, small cell in wireless cellular network). This reduces the number of locally deployed macro cells (macro base station). In such a topology the sensor nodes may communicate just locally to reduce the load on more central instances such as gateways and cloud resources. One or more of the UE in FIG. 9 are configured to perform one of the interference reporting methods described above.

In both topologies, star and mesh, a sensor node may be configured to perform a proper bootstrapping to connect to the wireless network, so as to be able to attach itself to the network automatically by attaching itself to a local cell or neighbouring mesh devices.

In one example for how to use the interference information reported by the UE, the interference information reported by the UE can be used as input parameters for machine learning (ML) algorithms. The BS apparatus uses the outcome of trained ML algorithms to predict the interference level for the UE and make a scheduling decision or a routing decision for the UE. Scheduling decisions might be made for UE connected in a star topology, shown in FIG. 8 by way of example, and routing decisions might be made for UE connected in a mesh topology, shown in FIG. 9 by way of example. In some embodiments, interference information from multiple UEs that collectively report over all of the time slots can be input parameters for machine learning (ML) algorithms. A training phase for the ML algorithms may be executed before a trained ML algorithm can later work on a subset of the available measured wireless channel state. When fully trained ML, only a subset of measured/sensed wireless channel states are needed and thus the power consumption of WSN is reduced further.

In another example for how to use the interference level on the time pattern reported from the UE, the apparatus may use advanced traditional schedule algorithms instead of ML algorithms. Traditional schedule algorithms need the reported interference level on the time pattern as input, and proportional-fair scheduling is a very common compromise-based schedule algorithm for wireless network. It is based upon maintaining a balance between two competing interests: trying to maximize total throughput of the wireless network while at the same time allowing all users at least a minimal level of service. This is done by assigning each data flow a data rate or a scheduling priority (depending on the implementation) that is inversely proportional to its anticipated resource consumption.

Numerous modifications and variations of the present disclosure are possible in light of the above teachings. It is therefore to be understood that within the scope of the appended claims, the disclosure may be practiced otherwise than as specifically described herein.

1. A method comprising:
receiving an indication to report interference information on a first time pattern, the first time pattern indicating at least two measurement time durations for which interference is to be measured;
transmitting interference information associated with the at least two measurement time durations, wherein the interference information associated with the at least two measurement time durations comprises one of:
a respective interference level for each of the at least two measurement time durations; or
an interference derivate based on measurements for the at least two measurement time durations; or
acceleration of the interference derivate based on the measurements for the at least two measurement time durations.

2. The method of claim 1, further comprising:
receiving an indication of the first time pattern.

3. The method of claim 2, wherein the receiving the indication to report the interference information comprises:
receiving a first message comprising the indication to report the interference information, and the receiving the indication of the first time pattern comprises:
receiving a second message comprising the indication of the first time pattern.

4. The method of claim 1, wherein the interference information associated with the at least two measurement time durations is for a specific azimuth angle.

5. The method of claim 4, further comprising one of:
receiving an indication of the specific azimuth angle; or
determining the specific azimuth angle as an azimuth angle with a worst interference for a given measurement time duration; or
determining the specific azimuth angle as an azimuth angle with a lowest interference for the given measurement time duration.

6. The method of claim 5, wherein the interference information associated with the at least two measurement time durations further includes the indication of the specific azimuth angle.

7. The method of claim 6, wherein the transmitting the interference information comprises one of:
transmitting a single bit indicating one of two interference levels or the interference derivate or the acceleration of interference derivate; or
transmitting two bits indicating one of up to four interference levels or the interference derivate or the acceleration of the interference derivate; or
transmitting three bits indicating one of up to eight interference levels or the interference derivate or the acceleration of the interference derivate.

8. A method comprising:
transmitting an indication to report interference information on a first time pattern, the first time pattern indicating at least two measurement time durations for which interference is to be measured;
receiving interference information associated with the at least two measurement time durations, wherein the interference information associated with the at least two measurement time durations comprises one of:
a respective interference level for each of the at least two measurement time durations; or
an interference derivate based on measurements for the at least two measurement time durations; or
acceleration of the interference derivate based on the measurements for the at least two measurement time durations.

9. The method of claim 8, further comprising:
transmitting an indication of the first time pattern.

10. The method of claim 9, wherein the transmitting the indication to report the interference information comprises:
transmitting a first message comprising the indication to report the interference information, and the transmitting the indication of the first time pattern comprises:
transmitting a second message comprising the indication of the first time pattern.

11. The method of claim 8, wherein the interference information associated with the at least two measurement time durations is for a specific azimuth angle.

12. The method of claim 11, wherein the method further comprises transmitting an indication of the specific azimuth angle; or
wherein the interference information associated with the at least two measurement time durations includes the indication of the specific azimuth angle.

13. The method of claim 8, further comprising:
making a scheduling or routing decision based on the interference information associated with the at least two measurement time durations.

14. The method of claim 8, wherein the receiving the interference information comprises one of:
receiving a single bit indicating one of two interference levels or the interference derivate or the acceleration of interference derivate; or
receiving two bits indicating one of up to four interference levels or the interference derivate or the acceleration of the interference derivate; or
receiving three bits indicating one of up to eight interference levels or the interference derivate or the acceleration of the interference derivate.

15. A non-transitory computer-readable medium having stored thereon, computer-executable instructions, that when executed by a computer, cause the computer to perform operations, the operations comprising:
receiving an indication to report interference information on a first time pattern, the first time pattern indicating at least two measurement time durations for which interference is to be measured;
transmitting interference information associated with the at least two measurement time durations, wherein the interference information associated with the at least two measurement time durations comprises one of:
a respective interference level for each of the at least two measurement time durations; or
an interference derivate based on measurements for the at least two measurement time durations; or
acceleration of the interference derivate based on the measurements for the at least two measurement time durations.

16. The non-transitory computer-readable medium of claim 15, the operations further comprising:
receiving an indication of the first time pattern.

17. The non-transitory computer-readable medium of claim 16, wherein the receiving the indication to report the interference information comprises:
receiving a first message comprising the indication to report the interference information, and the receiving the indication of the first time pattern comprises:
receiving a second message comprising the indication of the first time pattern.

18. The non-transitory computer-readable medium of claim 15, wherein the interference information associated with the at least two measurement time durations is for a specific azimuth angle.

19. The non-transitory computer-readable medium of claim 18, the operations further comprising one of:
receiving an indication of the specific azimuth angle; or
determining the specific azimuth angle as an azimuth angle with a worst interference for a given measurement time duration; or
determining the specific azimuth angle as an azimuth angle with a lowest interference for the given measurement time duration.

20. The non-transitory computer-readable medium of claim 19, wherein the interference information associated with the at least two measurement time durations further includes the indication of the specific azimuth angle.
